(19) United States
(12) Patent Application Publication
(10) Pub. No.: US 2025/0304263 A1
(43) Pub. Date: Oct. 2, 2025

(54) ENVIRONMENTAL CONTROL SYSTEM USING ARCHITECTURE WITH TURBINES IN SERIES AND A MID-PRESSURE WATER SEPARATOR

(71) Applicant: Hamilton Sundstrand Corporation, Charlotte, NC (US)

(72) Inventors: Louis J. Bruno, Ellington, CT (US); Aiden Coutin, Ogden, UT (US); Kayla Gosse, Ellington, CT (US)

(21) Appl. No.: 19/018,427

(22) Filed: Jan. 13, 2025

Related U.S. Application Data
(60) Provisional application No. 63/573,050, filed on Apr. 2, 2024.

(51) Int. Cl. B64D 13/06

(52) U.S. Cl. CPC B64D 13/06; B64D 2013/0648; B64D 2013/0662

(57) ABSTRACT

An environmental control system of a vehicle includes a first inlet for receiving a first medium, a second inlet for receiving a second medium, a thermodynamic device operably coupled to the first inlet and the second inlet, and an expansion device operably coupled to the second inlet. The thermodynamic device includes a compressor and a plurality of turbines operably coupled by a shaft. The expansion device is independently operable from the thermodynamic device. The first inlet is fluidly coupled to a turbine of the plurality of turbines via a first flow path and the second inlet is fluidly connected to another turbine of the plurality of turbines via a second flow path. In at least one mode, the first medium is provided to the turbine and the another turbine in parallel.

### CROSS-REFERENCE TO RELATED APPLICATIONS

This application claims the benefit of U.S. Application No. 63/573,050 filed Apr. 2, 2024, the contents of which are incorporated by reference herein in its entirety.

### BACKGROUND

Embodiments of the disclosure relate to environmental control systems, and more specifically to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an environmental control system of a vehicle includes a first inlet for receiving a first medium, a second inlet for receiving a second medium, a thermodynamic device operably coupled to the first inlet and the second inlet, and an expansion device operably coupled to the second inlet. The thermodynamic device includes a compressor and a plurality of turbines operably coupled by a shaft. The expansion device is independently operable from the thermodynamic device. The first inlet is fluidly coupled to a turbine of the plurality of turbines via a first flow path and the second inlet is fluidly connected to another turbine of the plurality of turbines via a second flow path. In at least one mode, the first medium is provided to the turbine and the another turbine in parallel.

In addition to one or more of the features described above, or as an alternative to any of the foregoing embodiments in another mode, the compressor is only driven by energy extracted from the first medium within the another turbine.

In addition to one or more of the features described above, or as an alternative to any of the foregoing embodiments the thermodynamic device is operably coupled to the first inlet via the first flow path and operably coupled to the second inlet via the second flow path.

In addition to one or more of the features described above, or as an alternative to any of the foregoing embodiments including a cross-flow conduit connecting the first flow path and the second flow path and a valve operable to control a flow between the first flow path and the second flow path.

In addition to one or more of the features described above, or as an alternative to any of the foregoing embodiments when the valve is open, the second inlet is fluidly coupled to both the first flow path and the second flow path.

In addition to one or more of the features described above, or as an alternative to any of the foregoing embodiments when the valve is open, an outlet of the compressor is fluidly coupled to both the first flow path and the second flow path.

In addition to one or more of the features described above, or as an alternative to any of the foregoing embodiments a ram air circuit includes a ram air duct and having at least one ram heat exchanger arranged within the ram air duct.

In addition to one or more of the features described above, or as an alternative to any of the foregoing embodiments the at least one ram heat exchanger includes a primary heat exchanger and a secondary heat exchanger. The primary heat exchanger is disposed along the first flow path and the secondary heat exchanger being disposed along the second flow path.

In addition to one or more of the features described above, or as an alternative to any of the foregoing embodiments the primary heat exchanger and the secondary heat exchanger are arranged in series relative to a flow within the ram air duct.

In addition to one or more of the features described above, or as an alternative to any of the foregoing embodiments the primary heat exchanger and the secondary heat exchanger are arranged in parallel relative to a flow within the ram air duct.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

The FIGURE is a schematic diagram of an environmental control system pack according to an embodiment.

### DETAILED DESCRIPTION

A detailed description of one or more embodiments of the disclosed apparatus and method are presented herein by way of exemplification and not limitation with reference to the FIGS.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the FIGURE, an example of a schematic diagram of a portion of an environment control system (ECS) 20, such as an air conditioning unit or pack for example, is depicted according to a non-limiting embodiment. Although the environmental control system or ECS pack 20 is described with reference to an aircraft, alternative applications, such as another vehicle for example, are also within the scope of the disclosure. As shown, the ECS 20 may be configured to receive a first medium A1 at a first inlet 22. In embodiments where the ECS 20 is used in an aircraft application, the first medium A1 may be bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ECS 20 may alternatively or additionally be configured to receive a second medium A2 at a second inlet 24. In an embodiment, the second medium A2 is fresh air, such as outside air for example. The outside air can be procured via one or more scooping mechanisms, such as an impact scoop or a flush scoop for example. In such embodiments, the second inlet 24 can be considered a fresh or outside air inlet. In an embodiment, the second medium A2 is ram air drawn from a portion of a ram air circuit. Generally, the second medium A2 described herein is at an ambient pressure equal to an air pressure outside of the aircraft when the aircraft is on the ground and is between an ambient pressure and a cabin pressure when the aircraft is in flight.

As shown, the ECS 20 may include a ram air circuit 30 including a shell or duct 32 within which one or more heat exchangers are located. The ram air duct 32 can receive and direct a medium, such as ram air for example, through a portion of the ECS 20. The one or more heat exchangers arranged within the duct 32 are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the ram air duct 32 may be referred to as ram heat exchangers. In the illustrated, non-limiting embodiment, the at least one ram heat exchanger includes a first or primary heat exchanger 34 and a second or secondary heat exchanger 36. Within the heat exchangers 34, 36, ram air, such as outside air for example, acts as a heat sink to cool a medium passing there through, for example the first medium A1 and/or the second medium A2. Although a ram air circuit 30 having only two heat exchangers 34, 36 is illustrated, it should be understood that embodiments having only a single heat exchanger, or alternatively, more than two heat exchangers are also contemplated herein. Further, although the plurality of ram air heat exchangers 34, 36 are illustrated as being arranged in series relative to a flow through the ram air circuit 30, it should be understood that in other embodiments, the plurality of heat exchangers may be arranged in parallel or some combination of series and parallel.

The ECS 20 additionally includes at least one thermodynamic device 40, and in some embodiments includes a plurality of thermodynamic devices. Each thermodynamic device 40 is a mechanical device that includes components for performing thermodynamic work on a medium (e.g., extracts work from or applies work to the first medium A1, the second medium A2 by raising and/or lowering pressure and by raising and/or lowering temperature). Examples of a thermodynamic device include an air cycle machine, a two-wheel air cycle machine, a three-wheel air cycle machine, a four-wheel air cycle machine, etc.

In the illustrated, non-limiting embodiments, the ECS 20 includes a single thermodynamic device 40. However, embodiments including more than one thermodynamic device are also contemplated herein. The thermodynamic device 40 may include a compressor 42 and at least one turbine operably coupled by a shaft 44. In the illustrated, non-limiting embodiment, the thermodynamic device 40 includes three turbines 46, 48, and 50. In such embodiments, a medium, such as the first medium A1 for example, may be configured to flow through one or more the plurality of turbines 46, 48, 50 based on a mode of operation of the vehicle.

A compressor 42 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. In an embodiment, the compressor 42 utilizes a variable area diffuser. A turbine, such as any of turbines 46, 48, and 50 for example, is a mechanical device that expands a medium and extracts work therefrom (also referred to as extracting energy) to drive the compressor 42 via the shaft 44.

In the illustrated, non-limiting embodiment, the ECS 20 additionally includes an expansion device 52. The expansion device 52 is a mechanical device, similar to the thermodynamic device 40, and includes components for performing thermodynamic work on a medium (e.g., extracts work from or applies work to the first medium A1 by raising and/or lowering pressure and by raising and/or lowering temperature). Examples of the expansion device 52 include, but are not limited to, a simple air cycle machine or a tip turbine fan etc. Although the expansion device 52 is not described herein as a thermodynamic device, it should be understood that in some embodiments, the expansion device 52 may be considered a thermodynamic device.

In the illustrated, non-limiting embodiment, the expansion device 52 is a two-wheel air cycle machine including a turbine 54 and a fan 56 operably coupled via a shaft 58. However, it should be understood that any suitable expansion device, including an air cycle machine having any number of wheels (i.e., three-wheel or four-wheel) are also within the scope of the disclosure. The turbine 54 is a mechanical device that expands a medium and extracts work therefrom. In the expansion device 52, the turbine 54 drives rotation of the fan 56 via the shaft 58. In a non-limiting embodiment, the turbine 54, similar to turbines 46, 48, and 50, comprises a nozzle configured to accelerate a medium supplied thereto for entry into a turbine impeller (not shown). The fan 56 is a mechanical device that can force via push or pull methods a medium. For example, the fan 56 may be operable to move ram air through the shell 32 across the one or more ram heat exchangers 34, 36.

The ECS 20 may additionally include at least one dehumidification system 60. In the illustrated, non-limiting embodiment, the dehumidification system 60 includes at least one water extractor 62 and a reheater 64. The reheater 64 is a particular type of heat exchanger and the water extractor 62 is a mechanical device that removes water from a medium. As shown, the reheater 64 and the water extractor 62 are arranged to receive the first medium A1. In an embodiment, the dehumidification system additionally includes another water extractor 66. In such embodiments, the reheater 64 and the water extractor 66 are arranged to receive the second medium A2. However, it should be understood that the disclosed configuration of the dehumidification system is intended as an example only, and embodiments including one or more additional components are also within the scope of the disclosure.

The elements of the ECS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value. For instance, a first valve V1 may be configured to control a supply of the first medium A1 provided to the ECS 20. A second valve V2 may be operable to control a flow of a medium, such as the first medium A1 at a location upstream from the ram air circuit 30, to a power turbine 50. Valve V2 may be operated in flight to provide additional power to the compressor 42. A third valve V3 may be operable to allow a flow of the first medium A1 to bypass one of the turbines, such as the first turbine 46. Valve V3 is also operable to maintain the temperature at the outlet of the first turbine 46 above freezing.

A fourth valve V4 may be operable to allow a flow of the first medium A1 output from the primary heat exchanger 34 of the ram air circuit 30 to bypass the remainder of the ECS 20 and a fifth valve V5 may be operable to allow a flow of the second medium A2 to bypass one of the turbines, such as the 54 of the expansion device 52 to control a temperature of the second medium A2. A sixth valve V6 may be operable to provide surge control, a seventh valve V7 may be operable to allow a flow of the second medium A2 output from the turbine 54 of the expansion device to exhaust into the ram air circuit 30, such as at a location downstream from the heat exchangers 34, 36.

The ECS 20 has a first flow path associated with the first medium A1 and has a second flow path associated with the second medium A2. An eighth valve V8 and a corresponding cross-flow conduit 68 may be operable to selectively fluidly couple the flow path of the first medium A1 and the flow path of the second medium A2. When valve V8 is closed, the two flow paths remain fluidly separate from one another. However, when the eighth valve V8 is open, as will be described in more detail below, the second medium A2 is provided to both the first flow path and the second flow path of the ECS 20 in parallel. Further, when the eight valve V8 is open, the second valve V2 may be open such that the entirety of the first medium A1 from the inlet 22 flows to turbine 50 rather than towards the primary heat exchanger 34 and the eighth valve V8. In an embodiment, the eighth valveV 8 is a three-way valve operable to block a flow of the first medium A1 while allowing a flow of the second medium A2 therethrough.

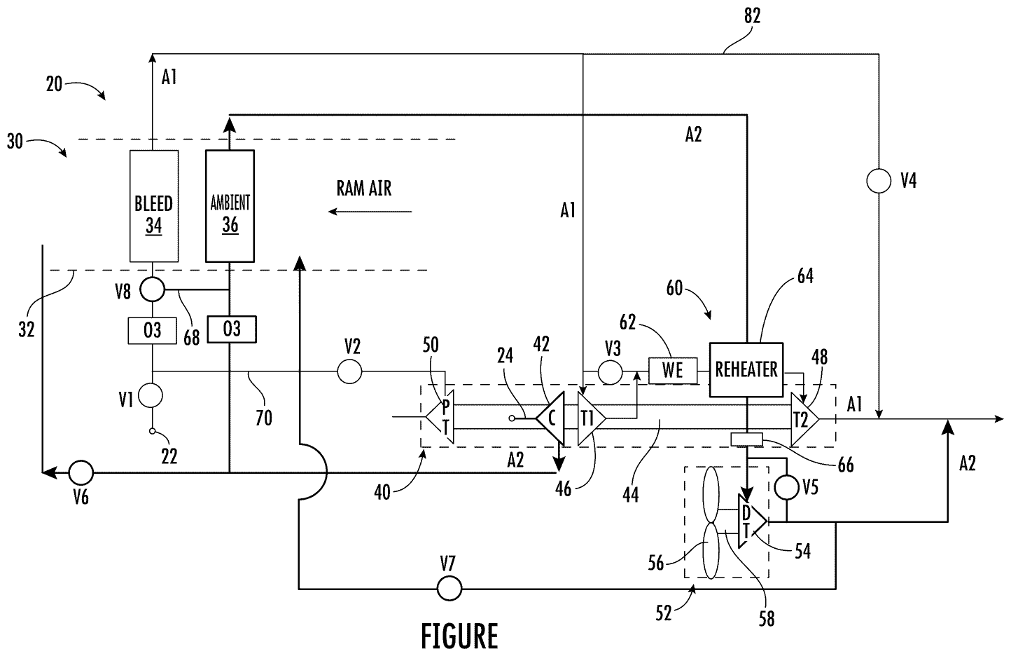

The environmental control system of FIG. 1 may be operable in a plurality of modes based on a flight condition of the aircraft. For example, the ECS 20 may be operable in a first mode such as during ground and low altitude flight conditions, for example ground idle, taxi, take-off, and hold conditions. During operation in the first mode, valve V1 is open, V2 is closed, and valve V8 is closed (relative to the flow from the conduit 68). Accordingly, a flow of high-pressure, high-temperature first medium A1 is provided from the first inlet 22 to the primary heat exchanger 34 of the ram air circuit 30. Ram air provided to the primary heat exchanger 34 cools the first medium A1 therein. An outlet of the primary heat exchanger 34 may be fluidly connected to an inlet of the first turbine 46. Accordingly, in the first mode, from the outlet of the heat exchanger 34, the cooler, high pressure first medium A1 enters the turbine 46 through a nozzle, where it is expanded and work is extracted. The work from the turbine 46 is used to drive the compressor 42 which is used to compress the second medium A2.

The temperature of the first medium A1 exiting the turbine 46 may be low enough to condense the moisture within the first medium A1. The first medium A1 output from the turbine 46 may then enter a water extractor 62 where the free moisture in the first medium A1 is removed. From the water extractor 62, the resulting cool, dry high pressure first medium A1 is provided to the reheater 64, where the first medium A1 is warmed by a flow of second medium A2. From the reheater 64, the warm, dry first medium A1 is provided to a second turbine 48 where it is expanded and work is extracted therefrom. Accordingly, in at least the first mode of operation, the first medium A1 is provided to the first turbine 46 and the second turbine 48 in series.

The work extracted from the first and second turbine 46, 48 is used to drive the compressor 42 which is used to compress the second medium A2 provided thereto from the second inlet 24. The act of compressing the second medium A2 heats it. The outlet of the compressor 42 may be directly fluidly connected to an inlet of the secondary heat exchanger 36. However, in some embodiments, the second medium A2 may pass through an ozone converter prior to reaching an inlet of the secondary heat exchanger 36. The compressed, hot second medium A2 enters the secondary heat exchanger 36 where the second medium A2 is cooled by a flow of ram air. In an embodiment, the second medium A2 is cooled within the secondary heat exchanger 36 to a nearly ambient temperature.

The outlet of the secondary heat exchanger 36 may be fluidly connected to a portion of the dehumidification system 60. As shown, the cool second medium A2 enters the reheater 64, where it is cooled by a flow of the first medium A1 output from the second turbine 48. As the second medium A2 is cooled within the reheater 64, moisture is condensed from the second medium. The second medium A2 then enters a water extractor 66 where any free moisture in the second medium A2 is removed. This cool dry second medium A2 then enters the turbine 54 of the expansion device 52 where it is expanded and work is extracted therefrom. The act of extracting work from the second medium A2 within the turbine 54 cools the second medium A2 and drives the fan 56 about its axis. The flow of the second medium A2 output from the turbine 54, such as directly output from the turbine 54 may then be mixed with the flow of first medium A1 output from the second turbine 48, such as directly downstream from the outlet of the second turbine 48, to form a conditioned medium ready for delivery to one or more loads, such as the cabin for example.

The ECS may also be operable in a second mode. The second mode may be associated with “high-altitude” operation suitable for use during flight conditions such as at high altitude cruise, climb, and descent flight conditions. Operation of the ECS 20 in the high-altitude mode may be similar to operation on the ground. Accordingly, high pressure, high temperature first medium A1 is provided to the ram air circuit 30 and to the first turbine 46 and the second turbine 48 in series. Similarly, the second medium A2 is compressed at the compressor 42, cooled within the ram air circuit 30, further cooled by the first medium A1 within the dehumidification system 60, and work is then extracted therefrom in the expansion device 52.

In an embodiment, the distinction between the first mode and the second mode of operation is that in the second mode, the second valve V2 is open. Accordingly, a flow of high pressure, high temperature first medium A1 from the inlet 22 is directed to another turbine, such as the third turbine 50 of the thermodynamic device 40, via a conduit 70 fluidly coupling and defining a third flow path extending between the first inlet 22 and the thermodynamic device 40. In such embodiments, the first inlet 22 is fluidly connected to the primary heat exchanger 34, and therefore the first and second turbine 46, 48 via the first flow path, in parallel with the third turbine 50. Accordingly, a first portion of the first medium A1 at the first inlet 22 may be provided to the ram air circuit 30 and a second portion of the first medium A1 received at the first inlet 22 may simultaneously be provided to the thermodynamic device 40, i.e., third turbine 50. The second portion of the first medium A1 provided to the third turbine 50 is expanded and work is extracted therefrom. This work is used to drive the compressor 42 and is supplemental to the work extracted in the first turbine 46 and the second turbine 48.

A third mode of operation of the ECS 20 may be associated with failure operation. In the event of a failure of a pressurized air system and/or of another ECS pack during flight, a remaining functional ECS pack, such as ECS pack 20 for example, may be configured to meet the demands of the aircraft. To maintain the pressure and/or flow rate requirements associated with operation in such a failure mode, the remaining operational ECS or ECS pack 20 may be operated in a “single pack” or third mode of operation. Operation in the third mode may be similar to operation in the second, high-altitude mode.

High pressure first medium A1 from the first inlet 22 passes through the ram air circuit 30 and at least one of the first turbine 46 and second turbine 48. The energy extracted from the first medium A1 at one of the first turbine 46 and second turbine 48 is used to drive the compressor. Additional energy is provided to the compressor 42 via a flow of medium, such as the first medium A1, supplied directly to the power turbine 50, such as by fully opening valve V2 for example, to meet cabin demands.

The ECS 20 may also be operable in a fourth, 100% ambient air mode. In this fourth mode, valves V8, V4 and V5 are open. Accordingly, when valve V8 is open, the outlet of the compressor 42 is fluidly connected to the inlet of the secondary heat exchanger 36 and to the inlet of the primary heat exchanger 34 (via the cross-flow conduit 68) in parallel. As a result, the second medium A2 downstream from the compressor 42 is configured to flow through both the first flow path and the second flow path in parallel. In the 100% ambient air mode, the second medium A2 is compressed at the compressor 42. The flow of compressed second medium A2 output from the compressor 42 is then split into a first portion provided to the inlet of the primary heat exchanger 34 and a second portion provided to the inlet of the secondary heat exchanger 36 simultaneously. Splitting the flow of the second medium A2 lowers the compressor discharge pressure and reduces overall power of the ECS 20.

Because valve V4 is open, the flow of the cool first portion of the second medium A2 output from the first heat exchanger 34 is configured to bypass the remainder of the ECS 20 via the bypass conduit 82. Accordingly, in the 100% ambient mode, the first flow path bypasses the thermodynamic device 40. After being cooled within the second heat exchanger 36, the second portion of the second medium A2 is then delivered to the reheater 64. Because no flow of first medium A1 is provided to the reheater in the 100% ambient mode, no conditioning of the second portion of the second medium A2 occurs within the reheater 64. From an outlet of the reheater 64, the second portion of the second medium A2 passes through the water extractor 66 where any free moisture therein is removed. In the 100% ambient air mode, the second portion of the second medium A2 is configured to bypass the turbine 54 of the expansion device 52 via valve V5. Accordingly, in the 100% ambient mode, the second flow path bypasses the expansion device 52. After bypassing the expansion device 52, particularly the turbine 54, the second portion of the second medium A2 is then rejoined with the first portion of the second medium A2 from the first flow path and that was cooled via the primary heat exchanger 34 to form a conditioned medium suitable for delivery to one or more loads.

In the 100% ambient air mode, valves V1 and V2 are open and all of the first medium A1 from the inlet 22 is provided to the power turbine 50 to drive the compressor 42. In the 100% ambient mode, only power from the power turbine 50 is used to drive the compressor 42. No flow of medium is provided to either the first turbine 46 or the second turbine 48 of the thermodynamic device 40.

The ECS 20 as described herein is operable to provide a mixture of a first medium A1 and a second medium A2 to one or more loads, such as a cabin, during normal ground operation and altitude operation. However, in other embodiments, during high-altitude flight conditions, the ECS 20 may be configured to operate as described herein with respect to the fourth mode in which only the second medium A2 is provided to the load. In such embodiments, the ECS 20 may be operable to provide a mixture of the first medium A1 and the second medium A2 as described herein with respect to the second mode of operation during a failure of a pressurized air system and/or of another ECS pack during flight.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of a vehicle, the environmental control system comprising:
a first inlet for receiving a first medium;
a second inlet for receiving a second medium;
a thermodynamic device operably coupled to the first inlet and the second inlet, the thermodynamic device including a compressor and a plurality of turbines operably coupled by a shaft;
an expansion device operably coupled to the second inlet, the expansion device being independently operable from the thermodynamic device; and
wherein the first inlet is fluidly coupled to a turbine of the plurality of turbines via a first flow path and the second inlet is fluidly connected to another turbine of the plurality of turbines via a second flow path, wherein in at least one mode, the first medium is provided to the turbine and the another turbine in parallel.

2. The environmental control system of claim 1, wherein in another mode, the compressor is only driven by energy extracted from the first medium within the another turbine.

3. The environmental control system of claim 1, wherein the thermodynamic device is operably coupled to the first inlet via the first flow path and operably coupled to the second inlet via the second flow path.

4. The environmental control system of claim 3, further comprising:
a cross-flow conduit connecting the first flow path and the second flow path; and
a valve operable to control a flow between the first flow path and the second flow path.

5. The environmental control system of claim 4, wherein when the valve is open, the second inlet is fluidly coupled to both the first flow path and the second flow path.

6. The environmental control system of claim 4, wherein when the valve is open, an outlet of the compressor is fluidly coupled to both the first flow path and the second flow path.

7. The environmental control system of claim 3, further comprising a ram air circuit including a ram air duct and having at least one ram heat exchanger arranged within the ram air duct.

8. The environmental control system of claim 7, wherein the at least one ram heat exchanger includes a primary heat exchanger and a secondary heat exchanger, the primary heat exchanger being disposed along the first flow path and the secondary heat exchanger being disposed along of the second flow path.

9. The environmental control system of claim 8, wherein the primary heat exchanger and a secondary heat exchanger are arranged in series relative to a flow within the ram air duct.

10. The environmental control system of claim 8, wherein the primary heat exchanger and a secondary heat exchanger are arranged in parallel relative to a flow within the ram air duct.

11. A method of operating an environmental control system of a vehicle, the method comprising:
providing a thermodynamic device including a compressor and a plurality of turbines operably coupled by a shaft;
providing an expansion device independently operable from the thermodynamic device;
receiving a first medium at a first inlet, the first inlet being fluidly coupled to the thermodynamic device via a first flow path;
receiving a second medium at a second inlet, the second inlet being fluidly coupled to both the thermodynamic device and the expansion device via a second flow path; and
in a mode of operation, delivering a first portion of the first medium to a turbine of the plurality of turbines via the first flow path and delivering a second portion of the first medium to another turbine of the plurality of turbines via a third flow path, wherein the first portion of the first medium and the second portion of the first medium is delivered to the turbine and to the another turbine simultaneously.

12. The method of claim 11, further comprising cooling the first portion of the first medium upstream from the turbine.

13. The method of claim 11, further comprising mixing the first portion of the first medium with the second medium upstream from one or more loads.

14. The method of claim 11, wherein no conditioning of the second portion of the first medium occurs between the first inlet and the another turbine.

15. A method of operating an environmental control system of a vehicle, the method comprising:
providing a thermodynamic device including a compressor and a plurality of turbines operably coupled by a shaft;
providing an expansion device independently operable from the thermodynamic device;
receiving a first medium at a first inlet, the first inlet being movable through the environmental control system along a first flow path;
receiving a second medium at a second inlet, the second inlet being movable through the environmental control system along a second flow path; and
delivering a first portion of the second medium to the first flow path; and
delivering a second portion of the second medium to the second flow path, wherein the delivering the first portion of the second medium to the first flow path and the delivering the second portion of the second medium to the second flow path occur simultaneously.

16. The method of claim 15, further comprising compressing the second medium within the compressor.

17. The method of claim 16, wherein delivering the first portion of the second medium to the first flow path occurs downstream from the compressing the second medium.

18. The method of claim 15, wherein the first flow path bypasses the thermodynamic device and the second flow path bypasses the expansion device.

19. The method of claim 15, further comprising directing the first medium from the first inlet to a turbine of the thermodynamic device via a third flow path.

20. The method of claim 19, wherein the compressor is only driven by energy extracted from the first medium within the turbine.
